(19) United States
(12) Patent Application Publication
(10) Pub. No.: US 2014/0004418 A1
(43) Pub. Date: Jan. 2, 2014

(54) SLURRY COMPOSITION FOR NEGATIVE ELECTRODE OF LITHIUM ION SECONDARY CELL, NEGATIVE ELECTRODE OF LITHIUM ION SECONDARY CELL, AND LITHIUM ION SECONDARY CELL

(71) Applicants: Kei Kobayashi, Tokyo (JP); Kenji Arai, Yokohama-shi (JP)

(72) Inventors: Kei Kobayashi, Tokyo (JP); Kenji Arai, Yokohama-shi (JP)

(73) Assignee: ZEON CORPORATION, Tokyo (JP)

(21) Appl. No.: 14/005,775

(22) PCT Filed: Mar. 15, 2012
(86) PCT No.: PCT/JP2012/056724

§ 371 Date: Sep. 17, 2013

(30) Foreign Application Priority Data
Mar. 18, 2011 (JP) 2011-060917

(51) Int. Cl. H01M 4/13

(52) U.S. Cl. CPC H01M 4/13
USPC 429/211; 429/217

(57) ABSTRACT

To provide a slurry composition for a negative electrode of a lithium ion secondary cell, whereby a secondary cell having excellent cycle characteristics and output characteristics can be obtained, and whereby an electrode having excellent adhesion can be obtained. [Solution] This slurry composition for a negative electrode of a lithium ion secondary cell comprises a negative electrode active material, an aqueous dispersion binder, and water, and is characterized in that the specific surface area of the negative electrode active material is 3.0-20.0 m²/g, the aqueous dispersion binder is a polymer that contains dicarboxylic acid-containing monomer units and sulfonic acid-containing monomer units, the content ratio of dicarboxylic acid-containing monomer units in the polymer is 2-10% by mass, the content ratio of sulfonic acid-containing monomer units is 0.1-1.5% by mass, and the potassium ion content in the slurry composition is no more than 1000 ppm with respect to 100% by mass of the slurry composition.

### TECHNICAL FIELD

The present invention relates to a slurry composition for a lithium ion secondary battery negative electrode, a lithium ion secondary battery negative electrode and a lithium ion secondary battery.

### BACKGROUND ART

Recently, the portable terminals such as a laptop computer, PDA (Personal Digital Assistant) or so has are widely used. As the secondary battery used for the battery of these portable terminals, nickel hydride secondary battery, lithium ion secondary battery or so are widely used. As for the portable terminals, it has rapidly become more compact, thinner, lighter, and higher performances due to the demand to have further comfortable portability. As a result, the portable terminals are used in various situations. Also, for the battery, as similar to the portable terminals, it is demanded to be more compact, thinner, lighter, and have higher performances.

Conventionally as for the lithium ion secondary battery, the carbons based active materials such as graphite or so are used as the negative electrode active material. For example, Patent document 1 describes the negative electrode produced by coating and drying the slurry composition on the current collector, in which the slurry composition comprises the carbon based active materials and the binder compositions obtained by polymerizing the itaconic acids or so under the presence of the potassium persulfate.

Also, the lithium ion secondary battery negative electrode is developed using the alloy based active materials comprising Si or so in order to have larger capacity of the lithium ion secondary battery. However, the alloy based active materials expands•shrinks its volume when the lithium ion was doped•de-doped. As a result, the releasing of the negative electrode active material from the electrode (the powder fall-off) occurred, and the battery characteristics such as the cycle characteristic or the output characteristic or so were deteriorated.

### PRIOR ART DOCUMENT

Patent document 1: JP-A H09-213337

### SUMMARY OF THE INVENTION

### Technical Problems to be Solved by the Invention

As a result of keen examination by the inventors, in the slurry composition of the Patent document 1, potassium ion derived from the potassium persulfate as the polymerization initiator is present, and since the ion radius of the potassium ion is large, if the potassium ion is doped between the negative electrode active material layer, it is difficult to de-dope. As a result, it was found that this interfere the dope de-dope of the lithium ion to the negative electrode active material.

The present invention is achieved in view of such circumstances. That is, by using the slurry composition having little content ratio of potassium ion, the dope de-dope of the lithium ion to the negative electrode active material can be carried out good; thus as a result, it was found that the secondary battery having excellent battery characteristics such as cycle characteristic or the output characteristic can be obtained. Also, it was found that by using those having a specific surface area of particular range as the negative electrode active material, the output characteristic of the secondary battery can be improved. Further by using the water dispersible binder having a specific amount of carboxylic acid group containing monomer unit, and a specific amount of monomer unit containing sulfonic acid group, the binding force between the negative electrode active materials against each other, and the binding force between the negative electrode active material and the current collector is improved, and even if the alloy based active materials which easily expands and shrink is used, the powder fall-off can be suppressed thus the adhesiveness of the electrodes can be improved.

Therefore, the object of the present invention is to provide the secondary battery having excellent cycle characteristics and the output characteristic, and to provide the slurry composition for the lithium ion secondary battery negative electrode capable of obtaining the electrodes having excellent adhesiveness.

### Modes for Carrying Out the Invention

The gist of the present invention of which the object is to solve the above mentioned problems includes the following.

[1] A slurry composition for a lithium ion secondary battery negative electrode comprising a negative electrode active material, an water dispersible binder and water, wherein

a specific surface area of the negative electrode active material is 3.0 to 20.0 m²/g,

the water dispersible binder is formed from a polymer comprising monomer unit containing dicarboxylic acid group and monomer unit containing sulfonic acid group,

a content ratio of the monomer unit containing dicarboxylic acid group in said polymer is 2 to 10 wt %,

a content ratio of the monomer unit containing sulfonic acid group in said polymer is 0.1 to 1.5 wt %, and

a content of potassium ion in said slurry composition is 1000 ppm or less with respect to 100 wt % of said slurry composition.

[2] The slurry composition for the lithium ion secondary battery negative electrode as set forth in [1], wherein a film obtained by drying and molding the water dispersible binder to form the film has a residual stress of 5 to 30%, when carrying out a tension test after 6 minutes from 100% expansion of the film.

[3] The slurry composition for the lithium ion secondary battery negative electrode as set forth in [1] or [2] comprising an aqueous polymer having 1% aqueous solution viscosity of 100 to 3000 mPa·s.

[4] The slurry composition for the lithium ion secondary battery negative electrode as set forth in any one of [1] to [3], wherein said negative electrode active material includes alloy based active materials and carbon based active materials,

a content ratio of the alloy based active materials and the carbon based active materials is alloy based active materials/carbon based active materials is 20/80 to 50/50 (weight ratio).

[5] A lithium ion secondary battery negative electrode formed by coating and drying the slurry composition for the lithium ion secondary battery negative electrode as set forth in any one of [1] to [4] to the current collector.

[6] A lithium ion secondary battery comprising a positive electrode, a negative electrode, a separator and an electrolytic solution, wherein said negative electrode is the lithium ion secondary battery negative electrode as set forth in [5].

### Effect of the Present Invention

According to the present invention, by using the slurry composition for the lithium ion secondary battery negative electrode comprising the negative electrode active material comprising the specific surface area of a particular range, the water dispersible binder formed by a polymer comprising specific amount of carboxylic acid group containing monomer unit and monomer unit containing sulfonic acid group, and the water; and the content of potassium ion within specific range; even if the negative electrode active material repeats the expanding and the shrinking, the powder fall-off from the electrode can be suppressed, and the electrodes with excellent adhesiveness can be obtained. Also, since the content ratio of potassium ion in the slurry composition is little, dope de-dope of lithium ion to the negative electrode active material can be carried out good; thus as a result, the secondary battery having excellent cycle characteristic and the output characteristic can be obtained.

### Means for Carrying Out the Invention

In the following, (1) the slurry composition of the lithium ion secondary battery negative electrode, (2) the lithium ion secondary battery negative electrode and (3) the lithium ion secondary battery will be explained in this order.

(1) The Slurry Composition for the Lithium Ion Secondary Battery Negative electrode

The slurry composition for the lithium ion secondary battery negative electrode according to the present invention comprises a specific negative electrode and a specific water dispersible binder, and water.

### <The Negative Electrode Active Material>

The negative electrode active material used in the present invention is a substance which gives and takes the electron (lithium ion) in the lithium ion secondary battery negative electrode. The negative electrode active material preferably includes the alloy based active material and the carbon based active material. By using the alloy based active material and the carbon based active material as the negative electrode active material, the battery having layer capacity than the conventional battery having electrode obtained by using only the carbon based active material can be obtained, and the problems such as the lowering of the adhesive strength of the electrodes and the lowering of the cycle characteristic can be solved.

### [The Alloy Based Active Material]

The alloy based active material in the present invention refers to the active material which includes the element capable of inserting lithium in the structure, and the theoretical electrical capacity per weight in case the lithium is inserted is 500 mAh/g or more (the upper limit of the theoretical electrical value is not particularly limited, however it can be 5000 mAh/g or less); and specifically, lithium metal, elemental metals forming the lithium alloy or the alloy thereof, and oxides, sulfides, nitrides, silicides, carbibes, phosphides or so thereof can be used.

As the elemental metals and the alloy forming the lithium alloy, the compound comprising the metals of Ag, Al, Ba, Bi, Cu, Ga, Ge, In, Ni, P, Pb, Sb, Si, Sn, Sr, Zn or so may be mentioned. Among these, the elemental metals such as silicon (Si), tin (Sn), or lead (Pb) or so and the alloy including these elements, or the compound of these metals can be used.

The alloy based active material used in the present invention further comprises one or more of non-metal elements. Specifically, for example, SiC, SiOₓC_{y} (hereinbelow, it will be called as “Si—O—C”)(0<x≦3, 0<y≦5), Si₃N₄, Si₂N₂O, SiOₓ (0<x≦2), SnOₓ (0<x≦2), LiSiO, LiSnO or so may be mentioned, and among these SiOₓC_{y}, SiOₓ, and SiC are preferable since these are capable of inserting and releasing the lithium at low electrical potential. For example, SiOₓC_{y} can be obtained by firing the polymer material including the silicon. Among SiOₓC_{y}, the range of 0.8≦x≦3, and 2≦y≦4 is preferably due to the capacity and the cycle characteristic.

The oxides, sulfides, nitrides, silicides, carbides, phosphides of the element capable of inserting the lithium are mentioned as oxides, sulfides, nitrides, silicides, carbides, phosphides; and among these oxides are particularly preferable. Specifically, oxides of tin oxide, manganese oxide, titanium oxide, niobium oxide, vanacium oxide or so; lithium containing metal composite oxides including metal elements selected from a group consisting of Si, Sn, Pb, and Ti atoms may be used.

As the lithium containing metal composite oxides, further lithium titanium composite oxide shown by LiₓTi_{y}M_{z}O₄ (0.7≦x≦1.5, 1.5≦y≦2.3, 0≦z≦1.6, M is Na, K, Co, Al, Fe, Ti, Mg, Cr, Ga, Cu, Zn and Nb) may be mentioned, and among these Li_{4/3}Ti_{5/3}O₄, Li₁Ti₂O₄, Li_{4/5}Ti_{11/5}O₄ are used.

Among these, the material including the silicon is preferable, and SiOₓC_{y}, SiOₓ, and SiC of Si—O—C are particularly preferable. It is speculated that for these compounds, the insert and the release of Li to Si (Silicon) occurs under high electrical potential, and the insert and the release of Li to C (carbon) occurs under low electrical potential; and since the expanding and shrinking is suppressed than other alloy based active material, the effect of the present invention can be easily obtained.

The volume average particle diameter of the alloy based active material is preferably 0.1 to 50 μm, more preferably 0.5 to 20 μm, and particularly preferably 1 to 10 μm. If the volume average particle diameter of the alloy based active material is within this range, the production of the slurry composition for the lithium ion secondary battery negative electrode becomes easy. Note that, the volume average particle diameter in the present invention can be obtained from measuring the particle distribution by the laser diffraction.

The specific surface area of the alloy based active material is preferably 3.0 to 20.0 m²/g, more preferably 3.5 to 15.0 m²/g and particularly preferably 4.0 to 10.0 m²/g. By having the specific surface area of the alloy based active material within said range, the active site of the alloy based active material surface increases, thus the output characteristic of the lithium ion secondary battery becomes excellent.

### [The Carbon Based Active Material]

The carbon based active material used in the present invention refers to the active material having the carbon as a backbone capable of inserting the lithium, and specifically the carbon material and the graphite material may be mentioned. The carbon material generally refers to the carbon material having low graphitization (low crystallinity) of which the carbon precursor is heat treated (carbonization) at 2000° C. or lower (the lower limit of said treating temperature is not particularly limited, however for example, it can be 500° C. or higher). The graphite material refers to the graphite material comprising high crystallinity close to the graphite which is obtained by heat treating the easy-graphatizable carbon material at 2000° C. or higher (the upper limit of said treating temperature is not particularly limited, however for example, it can be 5000° C. or lower).

As for the carbon material, the easy-graphitizable carbon which easily changes the carbon structure depending on the heat treating temperature, and the hardly-graphitizable carbon which has a structure close to the amorphous structure which is represented by glassy carbon or so may be mentioned.

As the easy-graphitizable carbon, the carbon material having a tar pitch obtained from petroleum or coal or so as the source material may be mentioned; and for example, cokes, mesocarbon microbeads (MCMB), mesophase pitch carbon material, thermolysis vapor grown carbon fiber or so may be mentioned. MCMB is a carbon fine particle obtained by isolating and extracting the mesophase spherule which is generated during the heating of pitches at 400° C. or so. Mesophase pitch carbon fiber is a carbon fiber having the mesophase pitch obtained by growing and combining said mesophase spherule as the source material. The thermolysis vapor grown carbon fiber is a carbon fiber obtained by, (1) the method of thermolysing the acrylic polymer fiber or so, (2) the method of thermolysing the pitch by spinning, (3) the method of catalyst vapor deposition method (catalyst CVD) which vapor thermolyses the hydrocarbon using the catalyst of nano particles such as iron or so.

As the hardly-graphitizable carbon, phenol resin fired body, polyacrylonitrile carbon fiber, quaji-isotropic carbon, furfuryl alcohol resin fired body (PFA) or so may be mentioned.

As the graphite material, natural graphite, artificial graphite or so may be mentioned. As the artificial graphite, mainly the artificial graphite heat treated at 2800° C. or higher, graphitized MCMB heat treating MCMB at 2000° C. or higher, the graphitized mesophase pitch carbon fiber heat treating the mesophase carbon fiber at 2000° C. or higher or so may be mentioned.

Among the carbon material, graphite material is preferable. By using the graphite material, it becomes easy to increase the density of the negative electrode active material, and it becomes easy to produce the negative electrode having the density of the negative electrode active material layer of 1.6 g/cm³ or more (the upper limit of said density is not particularly limited, however it can be 2.2 g/cm³ or less). The negative electrode comprising the negative electrode active material layer having the density within said range can exhibit significantly effect of the present invention.

The volume average particle diameter of the carbon based active material is preferably 0.1 to 100 μm, more preferably 0.5 to 50 μm, and particularly preferably 1 to 30 μm. When the volume average particle diameter of the carbon based active material is within this range, the production of the slurry composition for the lithium ion secondary battery of the present invention becomes easy.

The specific surface area of the carbon based active material is preferably 3.0 to 20.0 m²/g, more preferably 3.5 to 15.0 m²/g, and particularly preferably 4.0 to 10.0 m²/g. When the specific surface area of the carbon based active material is within the above mentioned range, the active site of the carbon based active material surface increases, hence the output characteristic of the lithium ion secondary battery becomes excellent.

As for the mixing method of the alloy based active material and the carbon based active material, the dry method and the wet method or so may be mentioned; however the dry method is preferable since it can prevent the water dispersible binder, which will be described in the following, from adhering specifically to other active material.

The dry method mentioned here refers to the mixing of the powder of the alloy based active material and the powder of the carbon based active material using the mixing machine; and specifically, the solid portion concentration at the time of the mixing is 90 wt % or more, preferably 95 wt % or more, and more preferably 97 wt % or more. When the solid portion concentration during at the time of mixing is within said range, it can be dispersed uniformly while maintaining the particle shape, and the aggregation of the active material can be prevented.

As the mixing machine used during the dry mixing, a dry tumbler, a super mixer, a Henschel mixer, a flash mixer, an air blender, a flow jet mixer, a drum mixer, a ribbon cone mixer, a pug mixer, a nauta mixer, a ribbon mixer, a spartan granulator, a Loedige mixer, and a planetary mixer or so may be mentioned, and a screw-type kneader, a defoaming kneader, and a paint shaker, and kneaders such as a pressure kneader, and a two-roll kneader may be mentioned as examples.

Among the above mentioned mixing device, a mixer such as a planetary mixer that can achieve dispersion by stirring is preferable since the mixing of the active material is relatively easy; and a planetary mixer and a Henschel mixer are particularly preferable.

The content ratio of the alloy based active material and the carbon based active material is preferably 20/80 to 50/50, more preferably 25/75 to 45/55, and particularly preferably 30/70 to 40/60, in terms of weight ratio of (the alloy based active material)/(the carbon based active material). By mixing the alloy based active material and the carbon based active material within the above mentioned range, the battery having larger capacity than the conventional battery having the electrode obtained by only using the carbon based active material can be obtained; and the lowering of the adhesive force of the electrodes or the lowering of the cycle characteristic can be prevented.

### <The Water Dispersible Binder>

The water dispersible binder is formed from the polymer comprising the monomer unit containing dicarboxylic acid group and the monomer unit containing sulfonic acid group. The content ratio of the monomer unit containing dicarboxylic acid group in said polymer is 2 to 10 wt %, preferably 2 to 8 wt %, and more preferably 2 to 5 wt %. Also, the content ratio of the monomer unit containing sulfonic acid group in said polymer is 0.1 to 1.5 wt %, preferably 0.1 wt % to 1.2 wt %, and more preferably 0.2 to 1.0 wt %. By having the content ratio of the monomer unit containing dicarboxylic acid group and the monomer unit containing sulfonic acid group in said polymer within the above mentioned range, the slurry composition is suppressed from increasing the viscosity, and the covering of the negative electrode active material by the water dispersible binder becomes good; thus the high temperature storage characteristic of the secondary battery becomes excellent. Also, the production of the slurry composition becomes easy. Note that, the monomer unit containing dicarboxylic acid group is a repeating unit obtained by polymerizing the dicarboxylic acid group containing monomer, and the monomer unit containing sulfonic acid group is a repeating unit obtained by polymerizing the sulfonic acid group containing monomer.

As the dicarboxylic acid containing monomer, itaconic acid, fumaric acid, maleic acid or so may be mentioned; and among these, itaconic acid is preferable.

As the sulfonic acid group containing monomer, the monomer such as vinyl sulfonate, styrene sulfonate, allyl sulfonate, sulfoethyl(meth)acrylate, sulfopropyl(meth)acrylate, 2-acrylamide-2-methylpropanesulfonate (hereinafter, it may be referred as “AMPS”), 3-allyoxy-2-hydroxypropanesulfonate (hereinafter, it may be referred as “HAPS”) or so, and the salts thereof may be mentioned. Among these, AMPS or HAPS are preferable, and AMPS is more preferable.

Further, the water dispersible binder used in the present invention preferably includes besides the monomer unit mentioned in the above (that is, the monomer unit containing dicarboxylic acid group and the monomer unit containing sulfonic acid group), other monomer unit capable of copolymerizing therewith. The content ratio of said other monomer unit in said polymer is preferably 50 to 98 wt %, more preferably 70 to 96 wt %. By having the content ratio of other monomer unit in the polymer within the above mentioned range, the polymerization reaction proceeds stably, and the water dispersible binder excellent in the chemical stability and the mechanical stability can be obtained.

As other monomer constituting other monomer unit, styrene monomers such as styrene, chlorostyrene, vinyl toluene, t-butyl styrene, vinylbenzoate, methyl vinylbenzoate, vinyl naphthalene, chloromethylstyrene, α-methylstyrene, and divinyl benzene or so; olefins such as ethylene and propylene or so; monocarboxylic acid monomers such as acrylic acid and methacrylic acid or so; diene monomers such as 1,3-butadiene, isoprene or so; halogen atom-containing monomers such as vinyl chloride and vinylidene chloride or so; vinyl esters such as vinyl acetate, vinyl propionate, vinyl lactate or so; vinyl ethers such as methyl vinyl ether, ethyl vinyl ether, and butyl vinyl ether or so; vinyl ketones such as methyl vinyl ketone, ethyl vinyl ketone, butyl vinyl ketone, hexyl vinyl ketone, and isopropenyl vinyl ketone or so; heterocycle-containing vinyl compounds such as N-vinyl pyrrolidone, vinyl pyridine, and vinyl imidazole or so; amides monomer such as acrylic amide or so may be mentioned. Among these, styrene monomer, diene monomer, and monocarboxylic acid monomer are preferable. Note that, the water dispersible binder may include only one type of other monomer unit, or it may include two or more thereof by combining in arbitrary ratio.

The water dispersible binder used in the present invention, for example, can be produced by emulsion polymerizing in the water the monomer composition including the above mentioned monomer, preferably under the presence of the emulsifier and the polymerization initiator. Note that, during the emulsion polymerization, other additives can be blended as well. The number average particle diameter of the water dispersible binder is preferably 50 to 500 nm, and more preferably 70 to 400 nm. By having the number average particle diameter of the water dispersible binder within the above range, the strength and the flexibility of the obtained negative electrode can be made good.

As for the emulsifer, sodium dodecylbenzene sulfonate, sodium laurylsulfate, sodium dodecyldiphenylether disulfonate, sodium succinic acid dialkyl ester sulfonate or so may be mentioned; and among these, sodium dodecyldiphenylether disulfonate is preferable.

The used amount of the emulsifier is not particularly limited, and for example it is preferably 0.1 to 10.0 parts by weight, more preferably 0.15 to 5 parts by weight, and particularly preferably 0.2 to 2.5 parts by weight, with respect to 100 parts by weight of total of the above mentioned monomers. By having the used amount of the emulsifier within the above mentioned range, the polymerization reaction proceeds stably, and the water dispesible binder of the object can be obtained.

As the polymerization initiator, sodium persulfate (NaPS), ammonium persulfate (APS), potassium persulfate (KPS) or so may be mentioned; and among these, sodium persulfate or ammonium persulfate are preferable, and ammonium persulfate is more preferable. By using the ammonium persulfate or sodium persulfate as the polymerization initiator, the cycle characteristic of the obtained lithium ion secondary battery can be prevented from lowering.

The used amount of the polymerization initiator is not particularly limited, and for example, it is preferably 0.5 to 2.5 parts by weight, more preferably 0.6 to 2.0 parts by weight, and particularly preferably 0.7 to 1.5 parts by weight, with respect to total 100 parts by weight of the above mentioned monomers. By having the used mount of the polymerization initiator within said range, the viscosity of the slurry composition for the lithium ion secondary battery negative electrode is prevented from rising, and the stable slurry composition can be obtained.

As other additives, t-dodecyl mercaptan and α-methyl styrene dimer or so may be mentioned. The used amount of other additives is not particularly limited, and for example it is preferably 0 to 5 parts by weight, and more preferably 0 to 2.0 parts by weight, with respect to total 100 parts by weight of the above mentioned monomers.

In the water dispersible binder, sodium ion or potassium ion may be included as residue of the polymerization reaction container or the impurity of source materials. Also, by using the above mentioned emulsifier, the polymerization initiator, or other additives, sodium ion or potassium ion may be included in the water dispersible binder. Therefore, sodium ion or potassium ion may be released into the slurry composition for the lithium ion secondary battery of the present invention. In the present invention, the content of potassium ion in the slurry composition is 1000 ppm or less, preferably 500 ppm or less, more preferably 300 ppm or less, and particularly preferably 100 ppm or less with respect to 100 parts by weight of the slurry composition. In case the content of potassium ion in the slurry composition exceeds 1000 ppm, ions having large ion radius (potassium ion) enters between the layers of the negative active materials; thereby interferes the dope de-dope of lithium ion to the negative electrode active material. Also, the ratio of sodium ion with respect to total of sodium ion and potassium ion is preferably 90% or more, more preferably 95% or more, further preferably 98% or more, and particularly preferably 99% or more. By having the ratio of sodium ion with respect to total of sodium ion and potassium ion to 90% or more, the dope de-dope of lithium ion to the negative electrode active material can be carried out good, and as a result, the secondary battery having excellent battery characteristic such as cycle characteristic or the output characteristic can be obtained.

Also, by using the above mentioned polymerization initiator, sulfonic acid ion derived from the polymerization initiator may be included in the water dispersible binder. Therefore, sulfonic acid ion derived from the polymerization initiator may be released into the slurry composition for the lithium ion secondary battery of the present invention. In the present invention, the content of the sulfonic acid ion derived from the polymerization initiator in the slurry composition for the lithium ion secondary battery is not particularly limited, and it is 0.5 to 2.5 parts by weight, more preferably 0.6 to 2.0 parts by weight, and particularly preferably 0.7 to 1.5 parts by weight with respect to total 100 parts by weight of the above mentioned monomers. In the present invention, by having the content of the sulfonic acid ion derived from the polymerization initiator in the slurry composition for the lithium ion secondary battery within the above mentioned range, the viscosity of the slurry composition for the lithium ion secondary battery negative electrode is suppressed from rising, and the stable slurry composition can be obtained. Note that, in the present invention, ions released into the slurry composition for the lithium ion secondary battery negative electrode refers to sodium ion and potassium ion mentioned in the above, and the sulfonic acid ion derived from the polymerization initiator. The total amount of ions released into the slurry composition for the lithium ion secondary battery negative electrode is not particularly limited, and it is preferably 5000 to 30000 ppm, more preferably 7500 to 25000 ppm, and particularly preferably 10000 to 20000 ppm, with respect to 100 wt % of the slurry composition. By having the total amount of ions released into the slurry composition for the lithium ion secondary battery negative electrode within the above mentioned range, ions having large ion radius (potassium ion) is suppressed from entering in between the negative electrode active material layers, and the dope de-dope of lithium ion to the negative electrode active material can be carried out good. Also, the surface active function due to the counter cation (sodium ion or potassium ion) becomes excellent, thus the water dispersible binder becomes stable. The amount of each ion is measured by the inductively coupled plasma spectrometry (ICP analysis).

Also, in the water dispersible binder used in the present invention, the total amount of the dicarboxylic acid group containing monomer, the sulfonic acid group containing monomer and the polymerization initiator is preferably 2.5 to 10 parts by weight, more preferably 3 to 8 parts by weight, and particularly preferably 4 to 7 parts by weight, with respect to 100 parts by weight of entire monomer of the water dispersible binder. By having the total amount of the dicarboxylic acid group containing monomer, the sulfonic acid group containing monomer and the polymerization initiator within the above mentioned range, the viscosity of the slurry composition is suppressed from rising, and the covering of the negative electrode active material by the water dispersible binder becomes good; hence the obtained secondary battery has excellent high temperature storage characteristic. Also, the production of the slurry composition becomes easy.

The glass transition temperature of the water dispersible binder is preferably 25° C. or less, more preferably −100 to +25° C., more preferably −80 to +10° C., and most preferably −80 to 0° C. When the glass transition temperature of the water dispersible binder is within the above mentioned range, the characteristics such as the flexibility, the binding property, and winding property of the obtained negative electrode, and the adhesiveness between the negative electrode and the current collector or so are highly balanced out hence it is suitable.

Also, the water dispersible binder may be a binder formed by the polymer comprising the core shell structure obtained by polymerizing two or more monomer composition in step wise.

The content (the solid portion equivalent amount) of the water dispersible binder preferably 0.5 to 2.0 parts by weight and more preferably 0.7 to 1.5 parts by weight with respect to total 100 parts by weight of the negative electrode active material. When the content of the water dispersible binder is within the above mentioned range, the viscosity of the slurry composition for the lithium ion secondary battery is adjusted, and the coating can be carried out smoothly, further the negative electrode having small internal resistance and sufficient adhesive strength can be obtained. As a result, the binder releasing from the negative electrode active material during the electrode plate press step can be suppressed.

Also, for the water dispersible binder used in the present invention, the film obtained by drying and molding the water dispersible binder has a residual stress of preferably 5 to 30%, more preferably 7.5 to 25%, and particularly preferably 10 to 20% when carrying out the expansion test after 6 minutes from 100% expansion of the film. When said residual stress is within the above mentioned range, the negative electrode having excellent smoothness and the flexibility can be obtained.

The above mentioned residual stress can be measured by the following method. The water dispersible binder is dried at 25° C. for about 48 hours, and the film having the thickness of 0.25 mm is produced. Then, in accordance with ASTMD412-92, the obtained film is made into a specimen having a dumbbell shape specimen, and the expansion stress was applied to the both ends of the specimen at the speed of 500 mm/min. Next, the expansion is stopped when 20 mm of the standard area is doubled (100%), and the expansion stress (A) at the expansion is measured, and also the expansion stress (B) after 6 minutes expansion is measured. The ratio of the expansion stress (B) against the expansion stress (A) (=the expansion stress (B)/the expansion stress (A)) is calculated in percentage, and this is defined as the residual stress (%).

### <Water>

As the water used in the present invention, the water processed by the ion exchange resin (the ion exchange water), and the water processed by the reverse osmosis membrane water purifying system (the hyper pure water) or so may be mentioned. As for the electric conductivity of the water, the water having 0.5 mS/m or less is preferably used. In case the electric conductivity of the water exceeds the above mentioned range, due to the change of the absorbed amount of the aqueous polymer, which will be described in below, to the negative electrode active material, the dispersibility of the negative electrode active material in the slurry composition deteriorates, and it may cause an influence such as the lowering of the uniformity of the electrode or so. Note that, in the present invention, as long as it does not compromise the dispersing stability of the water dispersible binder, the hydrophilic solvent may be mixed with the water for use. As for the hydrophilic solvent, methanol, ethanol, N-methylpyrrolidone or so may be mentioned, and it is preferably 5 wt % or less with respect to the water.

### <The Aqueous Polymer>

In the slurry composition for the lithium ion secondary battery negative electrode of the present invention, it is preferable to comprise the aqueous polymer. As for the aqueous polymer, cellulose based polymer such as carboxymethyl cellulose (hereinafter, it may be referred as “CMC”), methyl cellulose, hydroxyethyl cellulose, hydroxypropylmethyl cellulose or so and the ammonium salts and alkaline metal salts thereof; (modified) poly(meth)acrylic acid and the ammonium salts and alkaline metal salts thereof; polyvinyl alcohols such as (modified) polyvinyl alcohols, copolymers of acrylic acid or an acrylic acid salt and a polyvinyl alcohol, and copolymers of maleic anhydride, maleic acid, or fumaric acid and a vinyl alcohol; polyethylene glycol, polyethylene oxide, polyvinylpyrrolidone, modified polyacrylic acid, oxidized starch, starch phosphate, casein, various modified starches or so may be mentioned. Among these, cellulose based polymer is preferable and CMC is particularly preferable.

In case of using the aqueous polymer, the 1% aqueous solution viscosity thereof is preferably 100 to 3000 mPa·s, more preferably 500 to 2500 mPa·s, and particularly preferably 1000 to 2000 mPa·s. When the 1% aqueous solution viscosity of the aqueous polymer is within the above mentioned range, the viscosity of the slurry composition can be made to that suitable for the coating, and since the drying time of the slurry composition can be short, the productivity of the lithium ion secondary battery is excellent. Also, the negative electrode having an excellent adhesiveness can be obtained. Said aqueous solution viscosity can be controlled by the average polymerization degree of the aqueous polymer. The higher the average polymerization degree is, the higher the aqueous solution viscosity tends to be. The average polymerization degree of the aqueous polymer is preferably 100 to 1500, more preferably 300 to 1200, and particularly preferably 500 to 1000. When the average polymerization degree of the aqueous polymer is within the above range, the 1% aqueous solution viscosity can be made into the above mentioned range, hence the above mentioned effect can be exhibited even more.

Said 1% aqueous solution viscosity is a value measured by a single-cylinder rotary viscometer in accordance with JIS Z8803:1991 (25° C., rotational speed of 60 rpm, spindle shape: 1).

In the present invention, the etherification degree of the cellulose based polymer suitable as the aqueous polymer is preferably 0.6 to 1.5, more preferably 0.7 to 1.2, and particularly preferably 0.8 to 1.0. By having the etherification degree of the cellulose base polymer within the above mentioned range, the affinity towards the negative electrode active material is lowered, hence the aqueous polymer is prevented from localizing at the negative electrode active material surface, and the adhesiveness of the negative electrode between the negative electrode active material layer and the current collector can be maintained, thus the adhesiveness of the negative electrode which is one of the object of the present invention can be significantly improved. Here, the etherification degree refers to the substitution degree of the carboxy methyl group or so to the hydroxyl group (3) per 1 unit of glucose anhydride in the cellulose. Theoretically, it can take a value of 0 to 3. It indicates that the larger the etherification degree is, the ratio of the hydroxyl group in the cellulose decreases and the ratio of the substitution increases; and the smaller the etherification degree is, the hydroxyl group in the cellulose increases and the substitution decreases. The etherification degree (the substitution degree) can be obtained from the following method and the formula.

First, 0.5 to 0.7 g of sample is scaled accurately, and incinerate in the magnetic crucible. After cooling, the obtained incinerated product is transferred to 500 ml beaker, then about 250 ml of water and 35 ml of N/10 sulfuric acid is added by pipette to boil for 30 minutes. This was cooled, then phenolphthalein indicator is added, then the excessive acid is reverse titrated using potassium hydroxide of N/10. Then the substitution degree is calculated from the following formula (I) and (II).

(Formula 1)

A=(a×f−b×f¹)/sample (g)−alkalinity (or + acidity) (I)

(Formula 2)

The substitution degree=M×A/(10000−80A) (II)

In the above formula (I) and (II), “A” is the amount (ml) of N/10 sulfuric acid consumed by binding alkaline metal ion in 1 g of the sample. “a” is the used amount (ml) of N/10 sulfuric acid. “f” is a titration coefficient of N/10 sulfuric acid. “b” is a titrating amount (ml) of N/10 potassium hydroxide. “f¹” is the titration coefficient of N/10 potassium hydroxide. “M” is the weight average molecular weight of the sample.

The blending amount of the aqueous polymer is preferably 0.5 to 2.0 parts by weight, more preferably 0.7 to 1.5 parts by weight with respect to total 100 parts by weight of the negative electrode active material. When the blending amount of the aqueous polymer is within said range, the coating property becomes good; hence the internal resistance is prevented from rising thus the adhesiveness with the current collector becomes excellent.

### <The Conductive Agent>

In the slurry composition for the lithium ion secondary battery negative electrode of the present invention, it is preferable to comprise the conductive agent. As for the conductive agent, the conductive carbons such as acetylene black, Ketchen black, carbon black, graphite, vapor-grown carbon fibers, and carbon nanotubes or so may be mentioned. By comprising the conductive agent, the electrical contact betwen the negative electrodes against each other can be improved; hence the discharge rate characteristic can be improved when used for the lithium ion secondary battery. The content of the conductive agent in the slurry composition for the lithium ion secondary battery negative electrode is preferably 1 to 20 parts by weight, and more preferably of 1 to 10 parts by weight with respect to total amount of 100 parts by weight of negative electrode active material.

### <The Arbitrary Component>

In the slurry composition for the lithium ion secondary battery negative electrode, besides the above mentioned component, arbitrary component may be further included. As the arbitrary component, a reinforcement material, a leveling agent, electrolytic additives having a function to suppress the electrolytic solution decomposition or so may be mentioned. Also, the arbitrary component may be included in the secondary battery negative electrode. These are not particularly limited as long as it does not influence the battery reaction.

As the reinforcement material, various filler of organic or inorganic having a shape of a spherical shape, a plate shape, a rod shape, or a fibrous shape can be used. By using the reinforcement material, strong and flexible negative electrode can be obtained; and an excellent long term cycle characteristic can be exhibited. The content of the reinforcement material in the slurry composition for the lithium ion secondary battery negative electrode is usually 0.01 to 20 parts by weight, and preferably 1 to 10 parts by weight, with respect to total 100 parts by weight of the negative electrode active material. By having the reinforcement material in the slurry composition for the lithium ion secondary battery negative electrode within the above mentioned range, high capacity and high load characteristic can be exhibited.

As the leveling agent, surfactants such as alkyl surfactant, a silicone surfactant, a fluoride surfactant, a metal surfactant or so may be mentioned. By mixing the leveling agent, the repelling caused during the coating, and the smoothness of the negative electrode can be improved. The content of the leveling agent in the slurry composition for the lithium ion secondary battery negative electrode is preferably 0.01 to 10 parts by weight with respect to total 100 parts by weight of the negative electrode active material. By having the leveling agent in the slurry composition for the lithium ion secondary battery negative electrode within the above mentioned range, the productivity during the production of the negative electrode, the smoothness and the battery characteristic become excellent.

As the electrolytic solution additives, vinylene carbonate or so used in the electrolytic solution may be used. The content of the electrolytic solution additives in the slurry composition for the lithium ion secondary battery negative electrode is preferably 0.01 to 10 parts by weight with respect to total 100 parts by weight of the negative electrode active material. By having the content of the electrolytic solution in the slurry composition for the lithium ion secondary battery negative electrode within the above mentioned range, the cycle characteristic and the high temperature characteristic of the obtained secondary battery becomes excellent. Further examples of the electrolytic solution additive may include nanoparticles of fumed silica and fumed alumina or so. By adding these nanoparticles, the thixotropy of the slurry composition can be controlled; thereby the leveling property of the obtained negative electrode can be improved. The content of the nanoparticles in the slurry composition for the lithium ion secondary battery negative electrode is preferably 0.01 to 10 parts by weight with respect to total 100 parts by weight of the negative electrode active material. By having the content of the nanoparticles in the slurry composition for the lithium ion secondary battery negative electrode within the above mentioned range, the stability and the productivity of the slurry becomes excellent and exhibits high battery characteristic.

### (The Production Method of the Slurry Composition for the Lithium Ion Secondary Battery Negative Electrode)

The slurry composition for the lithium ion secondary battery negative electrode can be obtained by mixing the above mentioned negative electrode active material, the water dispersible binder, and the aqueous polymer and the conductive agent used if needed, in the water.

The mixing method is not particularly limited, however for example it may be a mixing device of a stirring-type, a shaking-type, or a rotation-type. Further, the mixing may also be carried out using a dispersion kneader, such as a homogenizer, a ball mill, a sand mill, a roll mill, and a planetary kneader.

### (2) The Lithium Ion Secondary Battery Negative Electrode

The lithium ion secondary battery negative electrode of the present invention is formed by coating and drying the above mentioned slurry composition for the lithium ion secondary battery negative electrode to the current collector.

### (The Production Method of the Lithium Ion Secondary Battery Negative Electrode)

The method for producing the lithium ion secondary battery negative electrode of the present invention is not particularly limited; however the method of coating and drying the above mentioned slurry composition to the one side or the both sides of the current collector, then forming the negative electrode active material may be mentioned.

The method for coating the slurry composition on the current collector is not particularly limited. For example, a doctor blade method, a dipping method, a reverse roll method, a direct roll method, a gravure method, an extrusion method, and a brush painting method or so may be mentioned.

As for the drying method, the method of drying using warm air, hot air low humidity air, vacuum drying, and irradiation with (far) infrared or electron beam or so may be mentioned. The drying time is usually 5 to 30 minutes, and the drying temperature is usually 40 to 180° C.

When producing the lithium ion secondary battery negative electrode of the present invention, it is preferable to comprise a step to lower the porosity of the negative electrode active material layer by pressure applying treatment, using the metal mold or the roll press after said slurry composition is coated and dried on the current collector. A preferred porosity range is 5% to 30%, and more preferably 7% to 20%. If the porosity is too high, the charging efficiency and the discharging efficiency may deteriorate. If the porosity is too low, it may become difficult to obtain a high volume capacity, and the negative electrode active material layer can be easily released from the current collector, which tends to cause defects. Further, when using a curable polymer as the binder, it is preferably cured.

The thickness of the negative electrode active material layer of the lithium ion secondary battery negative electrode of the present invention is usually 5 to 300 μm, and preferably 30 to 250 μm. By having the thickness of the negative electrode active material layer within the above mentioned range, the secondary battery showing high characteristics of both the load characteristic and the cycle characteristic can be obtained.

In the present invention, the content ratio of the negative electrode active material in the negative electrode active material layer is preferably 85 to 99 wt %, and more preferably 88 to 97 wt %. When the content ratio of the negative electrode active material in the negative electrode active material layer is within said range, the secondary battery showing high capacity while having flexibility and the binding property can be obtained.

In the present invention, the density of the negative electrode active material of the lithium ion secondary battery negative electrode is preferably 1.6 to 1.9 g/cm³, and more preferably 1.65 to 1.85 g/cm³. By having the density of the negative electrode active material layer within said range, the secondary battery having high capacity can be obtained.

### <The Current Collector>

The current collector used in the present invention is not particularly limited, as long as it is a material that is electrically conductive and has electrochemical durability. However, the metal material comprising the heat resistance is preferable, and for example iron, copper, aluminum, nickel, stainless steel, titanium, tantalum, gold, platinum or so may be mentioned. Among these, as for the current collector used in the lithium ion secondary battery negative electrode, copper is particularly preferable. The shape of the current collector is not particularly limited, and a sheet shape having a thickness of about 0.001 to 0.5 mm is preferable. The current collector may be used by carrying out the surface roughening treatment in advance, in order to enhance the adhesive strength with the negative electrode active material layer. As for the surface roughening treatment, a mechanical polishing, an electropolishing, and a chemical polishing or so may be mentioned. As for the mechanical polishing, polishing paper to which polishing agent particles are fixed, a grind stone, an emery wheel, and a wire brush having steel wire or so may be used. Also, an intermediate layer may be formed on the current collector surface in order to enhance the adhesive strength or the electric conductivity of the negative electrode active material layer.

### (3) The Lithium Ion Secondary Battery

The lithium ion secondary battery of the present invention has a positive electrode, a negative electrode, a separator, and an electrolytic solution, wherein the negative electrode is the above mentioned lithium ion secondary battery negative electrode.

### <The Positive Electrode>

The positive electrode is formed by stacking the positive electrode active material including the positive electrode active material, and the binder for the positive electrode, on the current collector.

### [The Positive Electrode Active Material]

As the positive electrode active material, the active material capable of doping and de-doping the lithium ion is used, and it is largely separated into those made of organic compound and those made of inorganic compound.

The positive electrode active material consisting of the inorganic compound, transition metal oxides, transition metal sulfides, and lithium-containing composite metal oxides of lithium and a transition metal may be mentioned. As the above mentioned transition metal, Ti, V, Cr, Mn, Fe, Co, Ni, Cu, and Mo or so may be mentioned.

As for the transition metal oxides, MnO, MnO₂, V₂O₅, V₆O₁₃, TiO₂, Cu₂V₂O₃, amorphous V₂O—P₂O₅, MoO₃, V₂O₅, and V₆O₁₃ or so may be mentioned. Among these, MnO, V₂O₅, V₆O₁₃, TiO₂ are preferable. As the transition metal sulfides may include TiS₂, TiS₃, amorphous MoS₂, and FeS or so may be mentioned. As for the lithium containing composite metal oxides, the lithium containing composite metal oxides having a layered structure, the lithium containing composite metal oxides having a spinel structure, the lithium containing composite metal oxides having an olivine structure or so may be mentioned.

As the lithium containing composite metal oxides having a layered structure, lithium-containing cobalt oxide (LiCoO₂), lithium-containing nickel oxide (LiNiO₂), lithium composite oxides of Co—Ni—Mn, lithium composite oxides of Ni—Mn—Al, and lithium composite oxides of Ni—Co—Al or so may be mentioned. As the lithium containing composite metal oxides having a spinel structure, lithium manganate (LiMn₂O₄), and Li[Mn_{3/2}M_{1/2}]O₄ (here, M represents Cr, Fe, Co, Ni, Cu or so) in which some Mn are substituted with other transition metal or so may be mentioned. As the lithium containing composite metal oxides having an olivine structure, olivine type lithium phosphate compounds represented by LiₓMPO₄ (here, M represents at least one element selected from Mn, Fe, Co, Ni, Cu, Mg, Zn, V, Ca, Sr, Ba, Ti, Al, Si, B, and Mo, and 0≦x≦2) or so may be mentioned.

As the organic compound, for example the electroconductive polymers, such as polyacetylene and poly-p-phenylene or so may be used. Further, the iron oxides having poor electroconductivity can be used as the electrode active material covered by the carbon material, by providing the carbon source substance during the reduced firing. Further, these compounds may be partially substituted with another element. The positive electrode active material for the lithium ion secondary battery may also be a mixture of the aforementioned inorganic compound and organic compound.

The mean particle diameter of the positive electrode active material is usually 1 to 50 μm, and preferably is 2 to 30 μm. By setting the particle diameter within this range, the amount of the binder for the positive electrode in the positive electrode active material can be made low; hence the lowering of the battery capacity can be prevented. Also, in order to form the positive electrode active material layer, usually, the slurry including the positive electrode active material and the binder for the positive electrode (hereinafter, it may be referred as “the slurry composition for the positive electrode”) is prepared, and it becomes easy to prepare the viscosity suitable for the coating, thus the uniform positive electrode can be obtained.

The content ratio of the positive electrode active material in the positive electrode active material layer is preferably 90 to 99.9 wt %, and more preferably 95 to 99 wt %. By having the content of the positive electrode active material in the positive electrode active material layer within the above mentioned range, the high capacity can be exhibited, while exhibiting high flexibility and the binding property.

### [The Binder for the Positive Electrode]

As the binder for the positive electrode, it is not particularly limited, and a known binder may be used. For example, resins such as polyethylene, polytetrafluoroethylene (PTFE), polyvinylidene fluoride (PVDF), tetrafluoroethylene-hexafluoropropylene copolymers (FEP), polyacrylic acid derivatives, and polyacrylonitrile derivatives or so; the soft polymers such as acrylic soft polymer, diene soft polymer, olefin soft polymer, vinyl soft polymer or so may be used. These may be used alone, or by combining two or more thereof.

In the positive electrode, besides the above mentioned component as mentioned in the above, other components such as electrolytic additives having a function of electrolytic solution decomposition suppressor or so may be included. These are not particularly limited, as long as it does not influence the battery reaction.

As for the current collector, the current collector used in the lithium ion secondary battery negative electrode mentioned in above can be used; and it is not particularly limited as long as it is a material that is electrically conductive and has electrochemical durability. However, it is particularly preferred to use aluminum for the positive electrode of the lithium ion secondary battery.

The thickness of the positive electrode active material layer for the lithium ion secondary battery is usually 5 to 300 μm, and preferably 10 to 250 μm. By setting the thickness of the positive electrode active material layer within the above range, high characteristics are exhibited in both of a high load characteristic and a high energy density.

The positive electrode can be produced as same as the aforementioned negative electrode for the lithium ion secondary battery.

### <The Separator>

The separator is a porous substrate having pores. As for the usable separator, (a) porous separators having pores, (b) porous separators having a polymer coat layer formed on one surface or both surfaces thereof, and (c) porous separators having a porous resin coat layer formed thereon that contains inorganic ceramic powders or so may be mentioned. As non-limiting example of these, porous separators of polypropylenes, polyethylenes, polyolefins, or aramids or so; a polymer film for a solid polymer electrolyte or a gel polymer electrolyte made of, such as polyvinylidene fluoride, polyethylene oxide, polyacrylonitrile, or polyvinylidene fluoride-hexafluoropropylene copolymer, a separator coated with a gelated polymer coat layer, and a separator coated with a porous membrane layer formed of an inorganic filler and a dispersing agent for an inorganic filler may be mentioned.

### <The Electrolytic Solution>

The electrolytic solution used in the present invention is not particularly limited; and for example, a solution obtained by dissolving a lithium salt as a supporting electrolyte in a non-aqueous solvent may be used.

As the lithium salt, LiPF₆, LiAsF₆, LiBF₄, LiSbF₆, LiAlCl₄, LiClO₄, CF₃SO₃Li, C₄F₉SO₃L₁, CF₃COOLi, (CF₃CO)₂NLi, (CF₃SO₂)₂NLi, and (C₂F₅SO₂) NLi may be mentioned. LiPF₆, LiClO₄, and CF₃SO₃Li, are suitably used since it easily dissolves and show high dissociation degree. These can be used alone or by combining two or more thereof. The amount of the supporting electrolyte is usually 1 wt % or more and preferably 5 wt % or more, and usually 30 wt % or less and preferably 20 wt % or less, with respect to the electrolytic solution. If the amount of the supporting electrolyte is too little or too much, ionic conductivity deteriorates, and the charging property and discharging property of the battery deteriorate.

The solvent used in the electrolytic solution is not particularly limited, as long as it dissolves the supporting electrolyte. However, usually alkyl carbonates such as dimethyl carbonate (DMC), ethylene carbonate (EC), diethyl carbonate (DEC), propylene carbonate (PC), butylene carbonate (BC), and methylethyl carbonate (MEC) or so; esters such as γ-butyrolactone and methyl formate or so; ethers such as 1,2-dimethoxyethane and tetrahydrofuran or so; and sulfur containing compounds such sulfolane and dimethylsulfoxide or so are used. Dimethyl carbonate, ethylene carbonate, propylene carbonate, diethyl carbonate, and methylethyl carbonate are particularly preferable since these can easily attain the high ion conductivity, and has wide range of used temperature. These can be used alone or by combining two or more thereof. Also, the electrolytic solution can be used by comprising the additives. As the additives, compound of carbonates such as vinylene carbonate (VC) or so is preferable.

As the electrolytic solution other than the above mentioned, gel polymer electrolytes obtained by impregnating an electrolytic solution in a polymer electrolyte such as polyethylene oxide and polyacrylonitrile, and inorganic solid electrolytes such as lithium sulfide, LiI and Li₃N or so, may be mentioned.

### (The Production Method of the Lithium Ion Secondary Battery

The production method of the lithium ion secondary battery of the present invention is not particularly limited. For example, the negative electrode and the positive electrode may be stacked via the separator disposed therebetween, and this may be wound, folded or so depending on the shape of the battery, and then placed in a battery case. Then, an electrolyte solution may be injected into the battery case, and the case sealed. If necessary, expanded metal, an overcurrent prevention element such as a fuse and a PTC element, a lead plate or so may also be placed into prevent an increase in the internal pressure of the battery, and to prevent overcharge/discharge. The shape of the battery may be any of a laminate type, coin type, button type, sheet type, cylinder type, horn shape, and flat type.

### EXAMPLES

Hereinafter, the present invention will be described based on the examples, however the present invention is not be limited thereto. Note that, parts and % in the present examples are based on the weight unless mentioned otherwise. In the examples and the comparative examples, various physical properties are evaluated as following.

### <The Residual Stress of the Water Dispersible Binder>

The water dispersible binder was dried at 25° C. for about 48 hours, and the film having the thickness of 0.25 mm was produced. In accordance with ASTMD 412-92, the obtained film was made into a specimen having a dumb bell shape, and the expansion stress was applied to the both ends of the specimen at the speed of 500 mm/min. Then, the expansion was stopped when 20 mm of the standard area were doubled (100%), and the expansion stress (A) at the expansion was measured; and also the expansion stress (B) after 6 minutes expansion was measured. The ratio of the expansion stress (B) against the expansion stress (A) (=the expansion stress (B)/the expansion stress (A)) is calculated in a percentage, and this was defined as the residual stress (%).

### <The Measurement of 1% Aqueous Solution Viscosity of the Aqueous Polymer>

The powder of the aqueous polymer was dissolved in the ion exchange water to prepare 1% aqueous solution, then 1% aqueous solution viscosity (mPa·s) of the aqueous polymer was measured by a single-cylinder rotary viscometer in accordance with JIS Z8803:1991 (25° C., a rotational speed of 60 rpm, a spindle shape: 4).

<The Ratio of Sodium Ion with Respect to the Total Sum of Sodium Ion and Potassium Ion in the Slurry Composition>

By using the inductively coupled plasma spectrometry (ICP analysis), the amount of sodium ion and potassium ion in the slurry composition were measured, and the ratio (%) of sodium ion with respect to the total sum of sodium ion and potassium ion was calculated.

### <The Content of the Potassium Ion in the Slurry Composition>

By using the inductively coupled plasma spectrometry (ICP analysis), the amount of potassium ion with respect to 100 wt % of the slurry composition was measured.

### <The Viscosity Changing Rate of the Slurry Composition>

At the preparation of the slurry composition for the lithium ion secondary battery negative electrode, the viscosity changing rate of the slurry composition was obtained from the viscosity (η₁) of the slurry composition before adding the water dispersible binder, and the viscosity (η₂) of the slurry composition after adding the water dispersible binder and stirring for 40 minutes, and evaluated based on the following standard. The smaller the viscosity changing rate is, the more excellent the storage stability of the slurry is. Note that, the viscosity of the slurry composition was measured by a single-cylinder rotary viscometer in accordance with JIS Z8803:1991 (25° C., a rotational speed of 60 rpm, a spindle shape: 4).

The viscosity changing rate of the slurry composition (%)=100×(η₂−η₁)/η₁

A: Less than 5%
B: 5% or more and less than 10%
C: 10% or more and less than 15%
D: 15% or more and less than 20%
E: 20% or more and less than 25%
F: 25% or more

### <The Adhesive Strength of the Electrode Plate>

The obtained negative electrode was cut out in a form of rectangle having 1 cm width×10 cm length. The specimen was fixed with the surface of the electrode active material layer facing upwards. Cellophane tape was adhered to the electrode active material layer surface of the specimen. Then, the cellophane tap was peeled off in a 180° direction from one end of the specimen at a rate of 50 mm/min, and the stress thereupon was measured. The measurement was carried out for 10 times, and the average value thereof was taken as the peel strength. This peel strength was then evaluated based on the following standard. The larger the peel strength is, the greater the adhesion strength of the electrode is.

A: 6 N/m or more.
B: 5 N/m or more to less than 6 N/m
C: 4 N/m or more to less than 5 N/m
D: 3 N/m or more to less than 4 N/m
E: 2 N/m or more to less than 3 N/m
F: Less than 2 N/m

### <The Initial Charging Capacity>

The obtained coin cell type battery was charged at a constant current to 0.02 V by a 0.1 C constant current constant voltage charging method at 25° C., and the obtained capacity was taken as the initial charge capacity (mAh).

### <The High Temperature Cycle Characteristic>

Using the obtained coin cell type battery, the charge-discharge cycle was carried out by using the constant current constant voltage method of 0.1 C at 25° C., which charges until 0.02V by the constant electrical current; and charging until it reaches 0.02 C by the constant voltage, then discharging until it reaches 1.5 V by the constant voltage of 0.1 C. The charge discharge cycle was carried out for 50 cycles, and the electric capacity of the 50^{th} cycle with respect to the electric capacity of initial cycle (1^{st} cycle) was defined as the capacity maintaining ratio, and it was evaluated by the below standards. The higher this value is, the lesser the capacity reduction due to the repeating charge discharge characteristic is.

A: the capacity maintaining ratio was 70% or more.
B: the capacity maintaining ratio was 65% or more and less than 70%.
C: the capacity maintaining ratio was 60% or more and less than 65%.
D: the capacity maintaining ratio was 55% or more and less than 60%.
E: the capacity maintaining ratio was 50% or more and less than 55%.
F: the capacity maintaining ratio was less than 50%.

### <The Swelling Property of the Negative Electrode Plate>

In the glove box having an oxygen concentration of 0.1 ppm or less, the negative electrode is taken out by disassembling the battery after the above mentioned high temperature cycle test, then it washed by the mixture solvent of ethylene carbonate (EC)/diethylcarbonate (DEC) (EC/DEC=1/2 (volume ratio)). Then, it was further washed with diethylcarbonate (DEC) and dried. Then, the thickness of the negative electrode was measured, and the swelling property of the electrode plate is calculated from the following formula based on the thickness of the negative electrode plate and the thickness of the negative electrode before the battery production. It was evaluated based on the following standard. The smaller this value is, the more excellent the output characteristic is.

The swelling property of the electrode plate (%)=(the thickness of the negative electrode after the high temperature cycle test−the thickness of the negative electrode before the battery production)/the thickness of the negative electrode before the battery production×100

A: Less than 20%
B: 20% or more and less than 25%
C: 25% or more and less than 30%
D: 30% or more and less than 35%
E: 35% or more and less than 40%
F: 40% or more

### <The Output Characteristic>

By using the obtained coin cell type battery, the charge-discharge procedure was carried out under the condition of 25° C. by the charge discharge rate of 0.02V and 0.1 C respectively. Then, the charge-discharge procedure was carried out by 10 C, and the voltage V₁₀ after 10 seconds of discharging was measured. The output characteristic was evaluated by the voltage change shown by ΔV=0.02−V₁₀ (V), and it was evaluated based on the following standard.

A: Less than 0.1V
B: 0.1V or more and less than 0.15V
C: 0.15V or more and less than 0.2V
D: 0.2V or more and less than 0.25V
E: 0.25V or more and less than 0.3V
F: 0.3V or more

### Example 1

### The Production of the Water Dispersible Binder

40 parts of ion exchange water, 0.25 parts of sodium dodecyldiphenyletherdisulfonate, 0.4 parts of t-dodecylmercaptan (TDM), 0.6 parts of ammonium persulfate, 55.5 parts of styrene, 40 parts of 1,3-butadiene, 4 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%.

### [The Production of the Slurry Composition for the Lithium Ion Secondary Battery Negative Electrode]

Using carboxymethyl cellulose as the aqueous polymer (“Daicel 1380” manufactured by Dai-Ichi Kogyo Seiyaku Co.), an aqueous solution of 1.0% CMC was prepared. The viscosity of 1% CMC aqueous solution was measured. The results are shown in Table 1. Note that the etherification degree of CMC was 0.8.

As the negative electrode active material, the carbon based active material and the alloy based active material was used. Into a planetary mixer equipped with a disperser, 70 parts of artificial graphite (a volume average particle diameter of 20 μm, and a specific surface area of 4 m²/g) as a carbon based active material, 30 parts of Si—O—C active material (a volume average particle diameter of 10 μm, a specific surface area of 6 m²/g) as an alloy based active material, and 5 parts of acetylene black as a conductive material were placed. Then, it was stirred for 20 minutes only using the low speed blade.

Then, 1.0 part in terms of solid portion of the above mentioned 1.0% CMC aqueous solution portion was added thereto, and the solid concentration was adjusted with ion exchange water to 55%, and then the mixture was mixed for 60 minutes at 25° C. Then the solid concentration of the mixture was adjusted to 52% with ion exchange water, and the mixture was mixed for another 15 minutes at 25° C.

Then, the above mentioned water dispersible binder was added in an amount of 1.0 part in terms of solid portion, and further ion exchange water was introduced to control the final solid concentration to be 48%, then it was mixed for 10 minutes. Then, this was carried out with the defoaming treatment under the reduced pressure condition; thereby the slurry composition for the lithium ion secondary battery negative electrode having good fluidity was obtained. In regards with the slurry composition, <the ratio of the sodium ion with respect to the total sum of sodium ion and potassium ion in the slurry composition>, <the content of the potassium ion in the slurry composition>, and <the viscosity changing rate of the slurry composition> were evaluated. The result are shown in Table 1. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16400 ppm with respect to 100 wt % of the slurry composition.

### (The Production of the Lithium Ion Secondary Battery)

The slurry composition was applied with a comma coater at the speed of 0.5 m/min on one side of a 20 μm-thick copper foil so that the thickness of the film after drying would become about 200 μm, and dried for 2 minutes at 60° C. Then, heat treated for 2 minutes at 120° C. to obtain an electrode raw material. This raw material electrode was rolled with a roll press to obtain a lithium ion secondary battery negative electrode having an active material layer thickness of 80 μm and a density of 1.7 g/cm³. In regards with the negative electrode, <the adhesive strength of the electrode plate> was evaluated. The result is shown in Table 1.

The above mentioned lithium ion secondary battery negative electrode was cut into a disc shaped piece having a diameter of 12 mm, on the surface of the negative electrode active material layer side of this disc-shaped negative electrode, a separator formed of a disc-shaped polypropylene porous film having a diameter of 18 mm and a thickness of 25 μm, metal lithium as the positive electrode, and expanded metal were stacked in this order. This was placed in a coin type outer container formed of stainless steel equipped with polypropylene packing (a diameter 20 mm, a height 1.8 mm, a stainless steel thickness 0.25 mm). Into the container, an electrolytic solution was introduced so that no air remained in the container. A stainless steel cap having a thickness of 0.2 mm was fitted on the outer container via the polypropylene packing for sealing the battery can, thereby a lithium ion secondary battery (the coin cell battery) having a diameter of 20 mm and a thickness of about 2 mm was produced. Regarding the coin cell type battery, <the initial charging capacity>, <the high temperature cycle characteristic>, <the swelling property of the electrode plate>, and <the output characteristic> were evaluated. The results are shown in Table 1.

As the electrolytic solution, a solution obtained by dissolving LiPF₆ at a 1 mol/L concentration in a mixed solvent formed by mixing ethylene carbonate (EC) and diethyl carbonate (DEC) in a ratio of EC:DEC=1:2 (volume ratio at 20° C.) was used.

### Example 2

Except for using the water dispersible binder described in below, the slurry composition for the lithium ion secondary battery was obtained as same as the example 1, and produced the lithium ion secondary battery. The result of each evaluation is shown in Table 1. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 14500 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 56.9 parts of styrene, 40 parts of 1,3-butadiene, 2.6 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of the itaconic acid (the dicarboxylic acid group containing monomer), acrylic amide-2-methylpropane sulfonate (the sulfonic acid group containing monomer) and ammonium persulfate (the polymerization initiator) was 4.3 parts by weight with respect to 100 parts by weight of the entire monomer unit of the water dispersible binder. Also, in the water dispersible binder, the content ratio of the dicarboxylic acid monomer unit was 2.6%, and the content ratio of the monomer unit containing sulfonic acid group was 0.5%.

### Example 3

Except for using the water dispersible binder described in below, the slurry composition for the lithium ion secondary battery was obtained as same as the example 1, and produced the lithium ion secondary battery. The result of each evaluation is shown in Table 1. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 18600 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 52.5 parts of styrene, 40 parts of 1,3-butadiene, 7 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer) and the ammonium persulfate (the polymerization initiator) was 8.7 parts by weight with respect to 100 parts by weight of the entire monomer unit of the water dispersible binder. Also, in the water dispersible binder, the content ratio of the dicarboxylic acid monomer unit was 7%, and the content ratio of the monomer unit containing sulfonic acid group was 0.5%.

### Example 4

Except for using the water dispersible binder described in below, the slurry composition for the lithium ion secondary battery was obtained as same as the example 1, and produced the lithium ion secondary battery. The result of each evaluation is shown in Table 1. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16000 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 55.8 parts of styrene, 40 parts of 1,3-butadiene, 4 parts of itaconic acid, 0.2 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 5.4 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.2%.

### Example 5

Except for using the water dispersible binder described in below, the slurry composition for the lithium ion secondary battery was obtained as same as the example 1, and produced the lithium ion secondary battery. The result of each evaluation is shown in Table 1. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 17000 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 55.2 parts of styrene, 40 parts of 1,3-butadiene, 4 parts of itaconic acid, 0.8 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 6 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.8%.

### Example 6

Except for using the water dispersible binder described in below, the slurry composition for the lithium ion secondary battery was obtained as same as the example 1, and produced the lithium ion secondary battery. The result of each evaluation is shown in Table 1. Note that, the content of sulfonic acid ion derived from the polymerization initiator was 1.2 parts by weight with respect to total 100 parts by weight of the monomer constituting the water dispersible binder. Also, the total amount of the ion released into the slurry composition was 16400 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.5 parts of ammonium persulfate, 0.1 parts of potassium persulfate, 55.5 parts of styrene, 40 parts of 1,3-butadiene, 4 parts of itaconic acid, 0.5 parts of acrylamide-2-methylpropane sulfonate were placed into the pressure resistant container with a stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.5 parts of ammonium persulfate, 0.1 parts of potassium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), the acrylic amide-2-methylpropane sulfonate (the sulfonic acid group containing monomer), ammonium persulfate (the polymerization initiator), and potassium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%.

### Example 7

Except for using the water dispersible binder described in below, the slurry composition for the lithium ion secondary battery was obtained as same as the example 1, and produced the lithium ion secondary battery. The result of each evaluation is shown in Table 1. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 15400 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.15 parts of ammonium persulfate, 0.45 parts of potassium persulfate, 55.5 parts of styrene, 40 parts of 1,3-butadiene, 4 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.15 parts of ammonium persulfate, 0.45 parts of potassium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then, aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer), ammonium persulfate (the polymerization initiator), and potassium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%.

### Example 8

Except for using the styrene sulfonic acid instead of acrylamide-2-methylpropane sulfonate during the water dispersible binder production, the water dispersible binder and the slurry composition for the lithium ion secondary battery negative electrode were obtained as same as the example 1, thereby the lithium ion secondary battery was produced. The result of each evaluation is shown in Table 1. Note that, in the water dispersible binder, total amount of the itaconic acid (the dicarboxylic acid group containing monomer), styrene sulfonic acid (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Also, the content of the sulfonic acid ion derived from the polymerization initiator in the water dispersible binder was 1.2 parts by weight with respect to the total 100 parts by weight of the monomer constituting the slurry composition. Also, the total amount of the released ion into the slurry composition was 16500 ppm with respect to 100 wt % of the slurry composition.

### Example 9

Except for using the water dispersible binder described in below, the slurry composition for the lithium ion secondary battery was obtained as same as the example 1, and produced the lithium ion secondary battery. The result of each evaluation is shown in Table 1. Note that, the content of the sulfonic acid ion derived from the polymerization initiator was 0.5 parts by weight with respect to total 100 parts by weight of the monomer constituting the water dispersible binder. Also, the content of the sulfonic acid ion derived from the polymerization initiator in the water dispersible binder was 1.2 parts by weight with respect to the total 100 parts by weight of the monomer constituting the slurry composition. Also, the total amount of the ion released into the slurry composition was 11800 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.25 parts of ammonium persulfate, 57.2 parts of styrene, 40 parts of 1,3-butadiene, 2.3 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.25 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 3.3 parts by weight with respect to 100 parts by weight of the entire monomer unit of the water dispersible binder. Also, in the water dispersible binder, the content ratio of the dicarboxylic acid monomer unit was 2.3%, and the content ratio of the monomer unit containing sulfonic acid group was 0.5%.

### Example 10

Except for using the water dispersible binder of the below, the slurry composition for the lithium ion secondary battery was obtained as same as the example 1, and produced the lithium ion secondary battery. Also, the content of the sulfonic acid ion derived from the polymerization initiator in the water dispersible binder was 1.2 parts by weight with respect to the total 100 parts by weight of the monomer constituting the slurry composition. The result of each evaluation is shown in Table 1. Note that, the content of the sulfonic acid ion derived from the polymerization initiator was 0.5 parts by weight with respect to total 100 parts by weight of the monomer constituting the water dispersible binder. Also, the total amount of the ion released into the slurry composition was 8800 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.25 parts of ammonium persulfate, 57.7 parts of styrene, 40 parts of 1,3-butadiene, 2 parts of itaconic acid, 0.3 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.25 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then ammonium was added to control to pH of 8.5, thereby the water dispersible binder having the solid concentration of 40% was obtained. The residual stress of the water dispersible binder was calculated. The results are shown in Table 1. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 2.8 parts by weight with respect to 100 parts by weight of the entire monomer unit of the water dispersible binder. Also, in the water dispersible binder, the content ratio of the dicarboxylic acid monomer unit was 2%, and the content ratio of the monomer unit containing sulfonic acid group was 0.3%.

### Example 11

Except for using sodium hydroxide instead of aqueous ammonia, during the water dispersible binder production, the water dispersible binder and the slurry composition for the lithium ion secondary battery negative electrode was obtained as same as the example 1, thereby the lithium ion secondary battery was produced. The result of each evaluation is shown in Table 1. Note that, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 22900 ppm with respect to 100 wt % of the slurry composition.

### Example 12

Except for using 100 parts of alloy based active material (Si—O—C based active material (the volume average particle diameter of 10 μm, the specific surface area 6 m²/g)) during the production of the slurry composition for the lithium ion secondary battery negative electrode, the slurry composition was obtained as same as the example 1, thereby the lithium ion secondary battery was produced. The result of each evaluation is shown in Table 1. Note that, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16200 ppm with respect to 100 wt % of the slurry composition.

### Example 13

Except for using 80 parts of artificial graphite (the volume average particle diameter of 22 μm, the specific surface area 3.5 m²/g) as the carbon based active material and 20 parts of Si—O—C based active material (the volume average particle diameter of 10 μm, the specific surface area 6 m²/g) as the alloy based active material during the production of the slurry composition for the lithium ion secondary battery negative electrode, the slurry composition was obtained as same as the example 1, thereby the lithium ion secondary battery was produced. The results are shown in Table 1. Note that, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16200 ppm with respect to 100 wt % of the slurry composition.

### Example 14

Except for using 50 parts of artificial graphite (the volume average particle diameter of 25 μm, the specific surface area 3.5 m²/g) as the carbon based active material and 50 parts of Si—O—C based active material (the volume average particle diameter of 10 μm, the specific surface area 6 m²/g) as the alloy based active material during the production of the slurry composition for the lithium ion secondary battery negative electrode, the slurry composition was obtained as same as the example 1, thereby the lithium ion secondary battery was produced. The results are shown in Table 1. Note that, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16200 ppm with respect to 100 wt % of the slurry composition.

### Example 15

Except for using 100 parts of carbon based active material (the artificial graphite (the volume average particle diameter of 25 μm, the specific surface area 3.5 m²/g) as the negative electrode active material during the production of the slurry composition for the lithium ion secondary battery negative electrode, the slurry composition was obtained as same as the example 1, thereby the lithium ion secondary battery was produced. The results are shown in Table 1. Note that, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16200 ppm with respect to 100 wt % of the slurry composition.

### Example 16

Except for using sodium persulfate instead of ammonium persulfate during the water dispersible binder, the water dispersible binder and the slurry composition for the lithium ion secondary battery negative electrode was obtained as same as the example 1, thereby the lithium ion was produced. The result of each evaluation is shown in Table 1. Note that, the total amount of itaconic acid (the dicarboxylic acid group containing monomer), acrylic amide-2-methylpropane sulfonate (the sulfonic acid group containing monomer) and sodium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 18000 ppm with respect to 100 wt % of the slurry composition.

### Comparative Example 1

Except for using methacrylic acid instead of itaconic acid during the production of the water dispersible binder, the water dispersible binder and the slurry composition for the lithium ion secondary battery negative electrode was obtained as same as the example 1, thereby the lithium ion secondary battery was produced. The result is shown in Table 2. Note that, the total amount of acrylic amide-2-methylpropane sulfonate (the sulfonic acid group containing monomer) and ammonium persulfate (the polymerization initiator) was 1.7 parts by weight with respect to 100 parts by weight of the entire monomer unit of the water dispersible binder. Also, in the water dispersible binder, the content ratio of the dicarboxylic acid monomer unit was 0%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16000 ppm with respect to 100 wt % of the slurry composition.

### Comparative Example 2

Except for using the following water dispersible binder, the slurry composition for the lithium ion secondary battery negative electrode was obtained as same as the example 1, thereby the lithium ion secondary battery was produced. The result is shown in Table 2. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 15800 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 58.5 parts of styrene, 40 parts of 1,3-butadiene, 1 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 2. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 2.7 parts by weight with respect to 100 parts by weight of the entire monomer unit of the water dispersible binder. Also, in the water dispersible binder, the content ratio of the dicarboxylic acid monomer unit was 1%, and the content ratio of the monomer unit containing sulfonic acid group was 0.5%.

### Comparative Example 3

Except for using the following water dispersible binder, the slurry composition for the lithium ion secondary battery negative electrode was obtained as same as the example 1, thereby the lithium ion secondary battery was produced. The result is shown in Table 2. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 12000 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 47.5 parts of styrene, 40 parts of 1,3-butadiene, 12 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 2. Note that, in the water dispersible binder, the total amount of itaconic acid (the dicarboxylic acid group containing monomer), acrylic amide-2-methylpropane sulfonate (the sulfonic acid group containing monomer) and ammonium persulfate (the polymerization initiator) was 13.7 parts by weight with respect to 100 parts by weight of the entire monomer unit of the water dispersible binder. Also, in the water dispersible binder, the content ratio of the dicarboxylic acid monomer unit was 12%, and the content ratio of the monomer unit containing sulfonic acid group was 0.5%.

### Comparative Example 4

Except for using the following water dispersible binder, the slurry composition for the lithium ion secondary battery was obtained as same as the example 1, thereby the lithium ion secondary battery was produced. The result of each evaluation is shown in Table 2. Note that, the content of the sulfonic acid ion derived from the polymerization initiator was 0 parts by weight with respect to total 100 parts by weight of the monomer constituting the water dispersible binder. Also, the total amount of the ion released into the slurry composition was 14800 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of benzoyl peroxide (BPO), 56 parts of styrene, 40 parts of 1,3-butadiene, 4 parts of itaconic acid, were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of benzoyl peroxide (BPO) were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of the itaconic acid (the dicarboxylic acid group containing monomer), and the BPO (the polymerization initiator) was 5.2 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0%.

### Comparative Example 5

Except for using the following water dispersible binder, the slurry composition for the lithium ion secondary battery was obtained as same as the example 1, thereby the lithium ion secondary battery was produced. The result of each evaluation is shown in Table 2. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 17000 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of ammonium persulfate, 54 parts of styrene, 40 parts of 1,3-butadiene, 4 parts of itaconic acid, 2 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of ammonium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 1. Note that, in the water dispersible binder, the total amount of the itaconic acid (the dicarboxylic acid group containing monomer), the acrylic amide-2-methylpropane sulfonate (the sulfonic acid group containing monomer) and the ammonium persulfate (the polymerization initiator) was 7.2 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 2%.

### Comparative Example 6

Except for using the following water dispersible binder, the slurry composition for the lithium ion secondary battery was obtained as same as the example 1, thereby the lithium ion secondary battery was produced. The result of each evaluation is shown in Table 2. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16000 ppm with respect to 100 wt % of the slurry composition.

### (The Production of the Water Dispersible Binder)

40 parts of ion exchange water, 0.25 parts of sodium dodecyldiphenyletherdisulfonate, 0.4 parts of t-dodecylmercaptan (TDM), 0.6 parts of potassium persulfate, 55.5 parts of styrene, 40 parts of 1,3-butadiene, 4 parts of itaconic acid, 0.5 parts of acrylamide-2-methylpropane sulfonate were placed into the pressure resistant container with stirrer, thereby the emulsion of the monomer mixture was obtained by stirring. Next, 100 parts of ion exchange water, 0.25 parts of dodecyldiphenyletherdisulfonate were placed into the pressure resistant polymerization container with stirrer. Then the obtained mixture was heated at 75° C., and 10 parts of ion exchange water, 0.6 parts of potassium persulfate were added. To this mixture, the emulsion of the above mentioned monomer mixture was sequentially added over 240 minutes. After the addition of the emulsion of the above mentioned mixture was completed, the temperature was increased to 90° C., then when the monomer consumed amount reaches 95.0% after reacting for 240 minutes, the reaction was terminated by cooling. Then aqueous ammonia was added to control the pH to 8.5, thereby the water dispersible binder having the solid concentration of 40% was obtained. The residual stress of the water dispersible binder was calculated. The results are shown in Table 2. Note that, in the water dispersible binder, the total amount of itaconic acid (the dicarboxylic acid group containing monomer), acrylic amide-2-methylpropane sulfonate (the sulfonic acid group containing monomer) and potassium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%.

### Comparative Example 7

Except for using 70 parts of artificial graphite (the volume average particle diameter of 25 μm, the specific surface area 2.2 m²/g) as the carbon based active material and 30 parts of Si—O—C based active material (the volume average particle diameter of 23 μm, the specific surface area 1.8 m²/g) as the alloy based active material during the production of the slurry composition for the lithium ion secondary battery negative electrode, the slurry composition was obtained as same as the example 1, thereby the lithium ion secondary battery was produced. The results are shown in Table 2. Note that, the total amount of itaconic acid (the dicarboxylic acid group containing monomer), acrylic amide-2-methylpropane sulfonate (the sulfonic acid group containing monomer) and ammonium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Note that, the content of the sulfonic acid ion derived from the polymerization initiator was 1.2 parts by weight with respect to total 100 parts by weight of the monomer constituting the water dispersible binder. Also, the total amount of the ion released into the slurry composition was 16000 ppm with respect to 100 wt % of the slurry composition.

### Comparative Example 8

Except for using aqueous ammonia instead of potassium hydroxide during the production of the water dispersible binder, the water dispersible binder and the slurry composition for the lithium ion secondary battery negative electrode were obtained as same as the comparative example 6, thereby the lithium ion secondary battery was obtained. The result is shown in Table 2. Note that, in the water dispersible binder, the total amount of itaconic acid (the dicarboxylic acid group containing monomer), acrylic amide-2-methylpropane sulfonate (the sulfonic acid group containing monomer) and potassium persulfate (the polymerization initiator) was 5.7 parts by weight with respect to 100 parts by weight of the entire monomer unit of the water dispersible binder. Also, in the water dispersible binder, the content ratio of the dicarboxylic acid monomer unit was 4%, and the content ratio of the monomer unit containing sulfonic acid group was 0.5%. Also, the content of the sulfonic acid ion derived from the polymerization initiator was 1.2 parts by weight with respect to total 100 parts by weight of the monomer constituting the water dispersible binder. Also, the total amount of the ion released into the slurry composition was 16000 ppm with respect to 100 wt % of the slurry composition.

TABLE 1

| | | | Exam- | Exam- | Exam- | Exam- | Exam- | Exam- | Exam- | Exam- |
|---|---|---|---|---|---|---|---|---|---|---|
| | | | ple 1 | ple 2 | ple 3 | ple 4 | ple 5 | ple 6 | ple 7 | ple 8 |
| The material | monomer | 1,3-butadiene | 40 | 40 | 40 | 40 | 40 | 40 | 40 | 40 |
| of the water | | styrene | 55.5 | 56.9 | 52.5 | 55.8 | 55.2 | 55.5 | 55.5 | 55.5 |
| dispersible | | itaconic acid | 4 | 2.6 | 7 | 4 | 4 | 4 | 4 | 4 |
| binder | | methacrylic acid | | | | | | | | |
| (unit: parts | | AMPS | 0.5 | 0.5 | 0.5 | 0.2 | 0.8 | 0.5 | 0.5 | |
| by | | styrene sulfonate | | | | | | | | 0.5 |
| weight | emulsifier | sodium dodecyl- | 0.5 | 0.5 | 0.5 | 0.5 | 0.5 | 0.5 | 0.5 | 0.5 |
| (in terms of | | diphenylether- | | | | | | | | |
| the solid | | disulfonate | | | | | | | | |
| portion)) | polymerization | APS | 1.2 | 1.2 | 1.2 | 1.2 | 1.2 | 1.0 | 0.3 | 1.2 |
| | initiator | NaPS | | | | | | | | |
| | | KPS | | | | | | 0.2 | 0.9 | |
| | | BPO | | | | | | | | |
| Evaluations | The residual stress of the water | | 15 | 14 | 18 | 16 | 18 | 15 | 15 | 15 |
| | dispersible binder (%) | | | | | | | | | |
| | 1% aqueous solution viscosity of the | | 1500 | 1500 | 1500 | 1500 | 1500 | 1500 | 1500 | 1500 |
| | aqueous polymer (mPa · s) | | | | | | | | | |
| | The ratio of Na ion with respect to the | | 99.9 | 99.9 | 99.9 | 99.9 | 99.9 | 98.9 | 95 | 99.9 |
| | total sum of Na ion and K ion in the | | | | | | | | | |
| | slurry composition (%) | | | | | | | | | |
| | The content of K ion in the slurry | | 16.4 | 14.5 | 18.6 | 16 | 17 | 180 | 780 | 16.5 |
| | composition (ppm) | | | | | | | | | |
| | The viscosity changing rate of the slurry | | A | A | A | A | A | A | A | B |
| | composition | | | | | | | | | |
| | The adhesive strength of the electrode | | A | A | B | B | A | A | A | B |
| | plate | | | | | | | | | |
| | The initial charging capasity (mAh) | | 6.6 | 6.5 | 5.9 | 6.7 | 6.6 | 6.5 | 6.5 | 6.4 |
| | The high temperature characteristic | | A | A | C | A | A | A | C | C |
| | The swelling property of the electrode | | A | A | C | A | A | B | C | C |
| | plate | | | | | | | | | |
| | The output characteristic | | A | B | B | A | B | A | B | B |
| | | | Exam- | Exam- | Exam- | Exam- | Exam- | Exam- | Exam- | Exam- |
| | | | ple 9 | ple 10 | ple 11 | ple 12 | ple 13 | ple 14 | ple 15 | ple 16 |
| The material | monomer | 1,3-butadiene | 40 | 40 | 40 | 40 | 40 | 40 | 40 | 40 |
| of the water | | styrene | 57.2 | 57.7 | 55.5 | 55.5 | 55.5 | 55.5 | 55.5 | 55.5 |
| dispersible | | itaconic acid | 2.3 | 2 | 4 | 4 | 4 | 4 | 4 | 4 |
| binder | | methacrylic acid | | | | | | | | |
| (unit: parts | | AMPS | 0.5 | 0.3 | 0.5 | 0.5 | 0.5 | 0.5 | 0.5 | 0.5 |
| by | | styrene sulfonate | | | | | | | | |
| weight | emulsifier | sodium dodecyl- | 0.5 | 0.5 | 0.5 | 0.5 | 0.5 | 0.5 | 0.5 | 0.5 |
| (in terms of | | diphenylether- | | | | | | | | |
| the solid | | disulfonate | | | | | | | | |
| portion)) | polymerization | APS | 0.5 | 0.5 | 1.2 | 1.2 | 1.2 | 1.2 | 1.2 | |
| | initiator | NaPS | | | | | | | | 1.2 |
| | | KPS | | | | | | | | |
| | | BPO | | | | | | | | |

| | | | | | | | | | |
|---|---|---|---|---|---|---|---|---|---|
| Evaluations | The residual stress of the water | 16 | 18 | 18 | 15 | 15 | 15 | 15 | 15 |
| | dispersible binder (%) | | | | | | | | |
| | 1% aqueous solution viscosity of the | 1500 | 1500 | 1500 | 1500 | 1500 | 1500 | 1500 | 1500 |
| | aqueous polymer (mPa · s) | | | | | | | | |
| | The ratio of Na ion with respect to the | 99.9 | 99.9 | 99.9 | 99.9 | 99.9 | 99.9 | 99.9 | 99.9 |
| | total sum of Na ion and K ion in the | | | | | | | | |
| | slurry composition (%) | | | | | | | | |
| | The content of K ion in the slurry | 11.8 | 8.8 | 5 | 16.2 | 16.2 | 16.2 | 16.2 | 18 |
| | composition (ppm) | | | | | | | | |
| | The viscosity changing rate of the slurry | B | C | A | A | A | A | A | A |
| | composition | | | | | | | | |
| | The adhesive strength of the electrode | B | C | A | A | A | A | A | A |
| | plate | | | | | | | | |
| | The initial charging capasity (mAh) | 6.3 | 6.1 | 6.4 | 12.6 | 8.2 | 5.4 | 3.8 | 6.5 |
| | The high temperature characteristic | B | C | B | E | B | A | A | B |
| | The swelling property of the electrode | B | C | C | D | A | A | A | B |
| | plate | | | | | | | | |
| | The output characteristic | C | C | B | C | B | A | A | A |

TABLE 2

| | | | Com- | Com- | Com- | Com- | Com- | Com- | Com- | Com- |
|---|---|---|---|---|---|---|---|---|---|---|
| | | | parative | parative | parative | parative | parative | parative | parative | parative |
| | | | example 1 | example 2 | example 3 | example 4 | example 5 | example 6 | example 7 | example 8 |
| The material | monomer | 1,3-butadiene | 40 | 40 | 40 | 40 | 40 | 40 | 40 | 40 |
| of the water | | styrene | 55.5 | 58.5 | 47.5 | 56 | 54 | 55.5 | 55.5 | 55.5 |
| dispersible | | itaconic acid | | 1 | 12 | 4 | 4 | 4 | 4 | 4 |
| binder | | methacrylic acid | 4 | | | | | | | |
| (unit: parts | | AMPS | 0.5 | 0.5 | 0.5 | | 2 | 0.5 | 0.5 | 0.5 |
| by weight | | styrene sulfonate | | | | | | | | |
| (in terms of | emulsifier | sodium dodecyl- | 0.5 | 0.5 | 0.5 | 0.5 | 0.5 | 0.5 | 0.5 | 0.5 |
| the solid | | diphenylether- | | | | | | | | |
| portion)) | | disulfonate | | | | | | | | |
| | polymerization | APS | 1.2 | 1.2 | 1.2 | | 1.2 | | 1.2 | |
| | initiator | NaPS | | | | | | | | |
| | | KPS | | | | | | 1.2 | | 1.2 |
| | | BPO | | | | 1.2 | | | | |

| | | | | | | | | | |
|---|---|---|---|---|---|---|---|---|---|
| Evaluations | The residual stress of the water | 15 | 15 | 15 | 15 | 15 | 15 | 15 | 15 |
| | dispersible binder (%) | | | | | | | | |
| | 1% aqueous solution viscosity of the | 1500 | 1500 | 1500 | 1500 | 1500 | 1500 | 1500 | 1500 |
| | aqueous polymer (mPa · s) | | | | | | | | |
| | The ratio of Na ion with respect to the | 99.7 | 99.9 | 99.9 | 99.9 | 99.9 | 85 | 99.9 | 93 |
| | total sum of Na ion and K ion in the | | | | | | | | |
| | slurry composition (%) | | | | | | | | |
| | The content of K ion in the slurry | 16 | 15.8 | 12 | 14.8 | 17 | 5400 | 16 | 1200 |
| | composition (ppm) | | | | | | | | |
| | The viscosity changing rate of the slurry | F | E | A | D | A | A | A | A |
| | composition | | | | | | | | |
| | The adhesive strength of the electrode | E | E | B | D | B | B | C | B |
| | plate | | | | | | | | |
| | The initial charging capasity (mAh) | 5.4 | 5.6 | 5.2 | 5.9 | 5.7 | 6.4 | 6.1 | 6.4 |
| | The high temperature characteristic | F | E | E | E | D | D | C | D |
| | The swelling property of the electrode | F | E | E | D | D | E | B | E |
| | plate | | | | | | | | |
| | The output characteristic | F | F | F | E | E | D | F | D |

The following can be said according to the result of Table 1.

The lithium ion secondary battery produced by the slurry composition for the lithium ion secondary battery negative electrode comprising the negative electrode, the water dispersible binder and water, wherein a specific surface area of the negative electrode active material is 3.0 to 20.0 m²/g, the water dispersible binder is formed from a polymer comprising monomer unit containing dicarboxylic acid group and monomer unit containing sulfonic acid group, a content ratio of the monomer unit containing dicarboxylic acid group in said polymer is 2 to 10 wt %, a content ratio of the monomer unit containing sulfonic acid group in said polymer is 0.1 to 1.5 wt %, and a content of potassium ion in said slurry composition is 1000 ppm or less with respect to 100 wt % of said slurry composition (the examples 1 to 16), exhibits excellent balance of <the initial charging capacity>, <the high temperature cycle characteristic>, <the swelling property of the electrode plate>, and <the output characteristic>. Also, the viscosity changing rate of the slurry composition is good; hence the storage stability of the slurry composition is excellent, and also the adhesive strength of the negative electrode is excellent as well.

On the other hand, in case the water dispersible binder does not comprise the monomer unit containing dicarboxylic acid group in a predetermined amount (the comparative examples 1 to 3), in case the monomer unit containing sulfonic acid group is not comprised in a predetermined amount (the comparative examples 4 and 5), in case the potassium ion in the slurry composition exceeds 1000 ppm (the comparative example 6 and 8), and in case the specific surface area of the negative electrode is not within the predetermined range (the comparative example 7); then the balance of each evaluations deteriorates regarding the slurry composition for the lithium ion secondary battery negative electrode, the negative electrode, and the secondary battery.

1. A slurry composition for a lithium ion secondary battery negative electrode comprising a negative electrode active material, an water dispersible binder and water, wherein
a specific surface area of the negative electrode active material is 3.0 to 20.0 m²/g,
the water dispersible binder is formed from a polymer comprising a monomer unit containing dicarboxylic acid group and a monomer unit containing sulfonic acid group,
a content ratio of the monomer unit containing dicarboxylic acid group in said polymer is 2 to 10 wt %,
a content ratio of the monomer unit containing sulfonic acid group in said polymer is 0.1 to 1.5 wt %, and
a content of potassium ion in said slurry composition is 1000 ppm or less with respect to 100 wt % of said slurry composition.

2. The slurry composition for the lithium ion secondary battery negative electrode as set forth in claim 1, wherein a film obtained by drying and molding the water dispersible binder to form the film has a residual stress of 5 to 30%, when carrying out a tension test after 6 minutes from 100% expansion of the film.

3. The slurry composition for the lithium ion secondary battery negative electrode as set forth in claim 1 comprising an aqueous polymer having 1% aqueous solution viscosity of 100 to 3000 mPa·s.

4. The slurry composition for the lithium ion secondary battery negative electrode as set forth in claim 1, wherein said negative electrode active material includes alloy based active materials and carbon based active materials,
a content ratio of the alloy based active materials and the carbon based active materials is alloy based active materials/carbon based active materials is 20/80 to 50/50 (weight ratio).

5. A lithium ion secondary battery negative electrode formed by coating and drying the slurry composition for the lithium ion secondary battery negative electrode as set forth in claim 1 to the current collector.

6. A lithium ion secondary battery comprising a positive electrode, a negative electrode, a separator and an electrolytic solution, wherein said negative electrode is the lithium ion secondary battery negative electrode as set forth in claim 5.

7. The slurry composition for the lithium ion secondary battery negative electrode as set forth in claim 2 comprising an aqueous polymer having 1% aqueous solution viscosity of 100 to 3000 mPa·s.

8. The slurry composition for the lithium ion secondary battery negative electrode as set forth in claim 2, wherein said negative electrode active material includes alloy based active materials and carbon based active materials,
a content ratio of the alloy based active materials and the carbon based active materials is alloy based active materials/carbon based active materials is 20/80 to 50/50 (weight ratio).

9. The slurry composition for the lithium ion secondary battery negative electrode as set forth in claim 3, wherein said negative electrode active material includes alloy based active materials and carbon based active materials,
a content ratio of the alloy based active materials and the carbon based active materials is alloy based active materials/carbon based active materials is 20/80 to 50/50 (weight ratio).

10. A lithium ion secondary battery negative electrode formed by coating and drying the slurry composition for the lithium ion secondary battery negative electrode as set forth in claim 2 to the current collector.

11. A lithium ion secondary battery negative electrode formed by coating and drying the slurry composition for the lithium ion secondary battery negative electrode as set forth in claim 3 to the current collector.

12. A lithium ion secondary battery negative electrode formed by coating and drying the slurry composition for the lithium ion secondary battery negative electrode as set forth in claim 4 to the current collector.
